(19) United States
(12) Patent Application Publication
(10) Pub. No.: US 2002/0055930 A1
(43) Pub. Date: May 9, 2002

(54) Method, device and record medium for scope processing

(75) Inventor: Asuka Manki, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/867,421

(22) Filed: May 31, 2001

(30) Foreign Application Priority Data
May 31, 2000 (JP) 2000-162470

(51) Int. Cl. G06F 7/00

(52) U.S. Cl. 707/103 R

(57) ABSTRACT

Scope processing (for extracting one or more instances from an instance tree which has been stored in a database) is executed by use of a scope descriptor object which moves in an area of the instance tree that is designated by a starting position and a scope condition. The scope descriptor object starts moving in the instance tree from the starting position. The scope descriptor object generally goes down in the instance tree to an instance below the current instance if possible. When the downward movement is impossible or when the scope descriptor object went up in the instance tree, the scope descriptor object goes sideways to an instance next to the current instance if possible. When the sideways movement is impossible, the scope descriptor object goes up to an instance above the current instance if possible. The scope descriptor object stops the movement when is could not go down, when it could not go sideways and went up, and when it returned to the starting position. The scope descriptor object which stopped the movement extracts an instance of the current position if the current position is within the designated area. The scope descriptor object does not have to move throughout the instance tree, and thus the scope processing is completed in a short time.

### BACKGROUND OF THE INVENTION

The present invention relates to a method and a device for executing scope processing for extracting one or more desired instances from an MIB (Management Information Base) by use of instance tree information.

### DESCRIPTION OF THE RELATED ART

FIG. 1 is a block diagram showing an example of the composition of an OSI (Open Systems Interconnection) network management system (network management system which is constructed according to OSI). The OSI network management system shown in FIG. 1 is includes a network management system (NMS) 110 and a plurality of management target devices 100. Each management target device 100 is a network node of the management target network (OSI network management system) which is managed by the network management system 110. Concretely, the management target devices 100 are resources on the management target network such as a network element, a personal computer, a printer, etc. The network management system 110 monitors and manages the management target devices 100. A control section 111 of the network management system 110 controls the operation of the network management system 110 according to one or more programs stored in a storage device 112. A control section 101 of the management target device 100 controls the operation of the management target device 100 according to one or more programs stored in a storage device 102. Interface sections 114 and 104 of the network management system 110 and the management target devices 100 communicate information through the network.

The management target device 100 includes one or more devices as the targets of management. For example, the management target device 100 includes one or more “racks” each of which includes some “shelves” into each of which some “cards” are inserted. The “cards”, “shelves” and “racks” of the management target device 100 are devices as the targets of management.

An MIB (Management Information Base) 7 of the management target device 100 stores information concerning each device (card, shelf, rack, etc.) to be used for the network management etc. A set of information concerning a device (card, shelf, rack, etc.) which is stored in the MIB 7 is called an “instance”. The MIB 7, which is implemented by semiconductor memory, HDD (Hard Disk Drive), etc., also stores information concerning an “instance tree”. The instance tree (such as the one shown in FIG. 4) indicates the relationship (inclusion relationship etc.) between the instances of the management target device 100.

A “manager” 113 of the network management system 110 is a software module for executing processes necessary for the network management in the network management system 110, and an “agent” 103 of the management target device 100 is a software module for executing processes necessary for the network management in the management target device 100. The manager 113 and the agent 103 operate on CPUs (Central Processing Units) of the control sections 111 and 101, respectively. In the OSI network management system shown in FIG. 1, the agents 103 of the management target devices 100 and the manager 113 of the network management system 110 communicate information by use of CMIP (Common Management Information Protocol) and thereby the network management is executed.

When the agent 103 selects and extracts one or more desired instances from the instances existing in the MIB 7 (that is, when the agent 103 executes the “scope processing”), a method described below has been employed generally. In the conventional scope processing methods, each instance at a node of the instance tree has been stored in the MIB 7 together with its depth information indicating the depth of the instance from the root of the instance tree. When the scope processing is executed according to the conventional method, the agent 103 compares conditions designating instances to be extracted (conditions concerning depth) with the depth information of each instance existing in the instance tree of MIB 7, and thereby selects and extracts one or more instances having depth information satisfying the conditions.

However, in the conventional scope processing method, the agent 103 has to execute the comparison or judgment (whether or not the instance has depth information satisfying the conditions) with regard to all the instances existing in the instance tree, and thus the extraction of desired instances (scope processing) takes a long time. Further, each instance in the instance tree is stored together with its depth information, therefore, an extra memory area is required of the MIB 7 for storing the instance tree information.

### SUMMARY OF THE INVENTION

It is therefore the primary object of the present invention to provide a scope processing method and a scope processing device, by which the extraction of desired instances (scope processing) can be conducted in a short time,

Another object of the present invention is to provide a scope processing method and a scope processing device, by which the scope processing can be conducted successfully while reducing the amount of the instance tree information stored in memory such as the MIB 7.

In accordance with a first aspect of the present invention, there is provided a scope processing method for extracting one or more instances from an instance tree which has been stored in a database. In the scope processing method, the instances are extracted from the instance tree by use of a scope descriptor object which moves in an area of the instance tree that is designated by a starting position and a scope condition.

In accordance with a second aspect of the present invention, in the first aspect, the scope descriptor object which moves in the area designated by the starting position and the scope condition moves according to a movement starting step, a downward movement step, a sideways movement step, an upward movement step and a movement ending step. In the movement starting step, the scope descriptor object starts the movement in the instance tree from the starting position. In the downward movement step, the scope descriptor object at an instance of the instance tree generally goes down in the instance tree to an instance a step lower than the current instance if possible. The sideways movement step is executed when the scope descriptor object could not go down in the downward movement step or when the scope descriptor object went up in the instance tree. In the sideways movement step, the scope descriptor object goes sideways in the instance tree to an instance next to the current instance if possible. The upward movement step is executed when the scope descriptor object could not go sideways in the sideways movement step. In the upward movement step, the scope descriptor object goes up in the instance tree to an instance a step higher than the current instance if possible. In the movement ending step, the scope descriptor object ends the movement in the instance tree when the scope descriptor object returned to the starting position.

In accordance with a third aspect of the present invention, in the second aspect, when the scope descriptor object moves in the area designated by the starting position and the scope condition, the scope descriptor object stops the movement in the instance tree when the scope descriptor object could not go down in the downward movement step, when the scope descriptor object could not go sideways in the sideways movement step and went up in the upward movement step, and when the scope descriptor object returned to the starting position. The scope descriptor object which stopped the movement in the instance tree judges whether or not the current position is within the area designated by the starting position and the scope condition, extracts the instance of the current position if the current position is within the designated area, and restarts the movement in the instance tree from the current position if the scope descriptor object has not returned to the starting position.

In accordance with a fourth aspect of the present invention, in the third aspect, when the scope descriptor object extracts the instance of the current position, the instance is extracted if the instance satisfies a filtering condition.

In accordance with a fifth aspect of the present invention, in the third aspect, the scope descriptor object includes a stack area having areas corresponding to each relative depth with respect to the starting position. When the scope descriptor object went down in the downward movement step, information concerning an instance of the position after movement is stored in an area of the stack area corresponding to the relative depth of the position after movement. When the scope descriptor object went sideways in the sideways movement step, information concerning an instance of the position after movement is stored in an area of the stack area corresponding to the relative depth of the current position. When the scope descriptor object went up in the upward movement step, information concerning an instance of the position before movement is deleted from an area of the stack area corresponding to the relative depth of the position before movement. When the scope descriptor object extracts an instance of the current position, the scope descriptor object extracts the information concerning the instance from the area of the stack area corresponding to the relative depth of the current position.

In accordance with a sixth aspect of the present invention, in the fifth aspect, the information concerning the instance is information indicating the address of the instance which has been stored in a database such as an MIB (Management Information Base).

In accordance with a seventh aspect of the present invention, in the first aspect, the instance is a set of information concerning a device of a management target device.

In accordance with an eighth aspect of the present invention, in the seventh aspect, the management target device is a management target device in an OSI (Open Systems Interconnection) network management system.

In accordance with a ninth aspect of the present invention, there is provided a scope processing device of a management target device for extracting one or more instances from an instance tree which has been stored in a database. The scope processing device extracts the instances from the instance tree by use of a scope descriptor object which moves in an area of the instance tree that is designated by a starting position and a scope condition.

In accordance with a tenth aspect of the present invention, in the ninth aspect, the scope descriptor object which moves in the area designated by the starting position and the scope condition moves according to a movement starting step, a downward movement step, a sideways movement step, an upward movement step and a movement ending step. In the movement starting step, the scope descriptor object starts the movement in the instance tree from the starting position. In the downward movement step, the scope descriptor object at an instance of the instance tree generally goes down in the instance tree to an instance a step lower than the current instance if possible. The sideways movement step is executed when the scope descriptor object could not go down in the downward movement step or when the scope descriptor object went up in the instance tree. In the sideways movement step, the scope descriptor object goes sideways in the instance tree to an instance next to the current instance if possible. The upward movement step is executed when the scope descriptor object could not go sideways in the sideways movement step. In the upward movement step, the scope descriptor object goes up in the instance tree to an instance a step higher than the current instance if possible. In the movement ending step, the scope descriptor object ends the movement in the instance tree when the scope descriptor object returned to the starting position.

In accordance with an eleventh aspect of the present invention, in the tenth aspect, when the scope descriptor object moves in the area designated by the starting position and the scope condition, the scope descriptor object stops the movement in the instance tree when the scope descriptor object could not go down in the downward movement step, when the scope descriptor object could not go sideways in the sideways movement step and went up in the upward movement step, and when the scope descriptor object returned to the starting position. The scope descriptor object which stopped the movement in the instance tree judges whether or not the current position is within the area designated by the starting position and the scope condition, extracts the instance of the current position if the current position is within the designated area, and restarts the movement in the instance tree from the current position if the scope descriptor object has not returned to the starting position.

In accordance with a twelfth aspect of the present invention, in the eleventh aspect, when the scope descriptor object extracts the instance of the current position, the instance is extracted if the instance satisfies a filtering condition.

In accordance with a thirteenth aspect of the present invention, in the eleventh aspect, the scope descriptor object includes a stack area having areas corresponding to each relative depth with respect to the starting position. When the scope descriptor object went down in the downward movement step, information concerning an instance of the position after movement is stored in an area of the stack area corresponding to the relative depth of the position after movement. When the scope descriptor object went sideways in the sideways movement step, information concerning an instance of the position after movement is stored in an area of the stack area corresponding to the relative depth of the current position. When the scope descriptor object went up in the upward movement step, information concerning an instance of the position before movement is deleted from an area of the stack area corresponding to the relative depth of the position before movement. When the scope descriptor object extracts an instance of the current position, the scope descriptor object extracts the information concerning the instance from the area of the stack area corresponding to the relative depth of the current position.

In accordance with a fourteenth aspect of the present invention, in the thirteenth aspect, the information concerning the instance is information indicating the address of the instance which has been stored in a database such as an MIB (Management Information Base).

In accordance with a fifteenth aspect of the present invention, in the ninth aspect, the instance is a set of information concerning a device of the management target device.

In accordance with a sixteenth aspect of the present invention, in the fifteenth aspect, the management target device is a management target device in an OSI (Open Systems Interconnection) network management system.

In accordance with seventeenth through twenty-fourth aspects of the present invention, there are provided machine-readable record mediums storing programs for instructing a computer etc. to execute the scope processing methods of the first through eighth aspects of the present invention.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram showing an example of the composition of an OSI (Open Systems Interconnection) network management system;

FIG. 2 is a schematic diagram showing a scope descriptor object which executes a scope processing method in accordance with a first embodiment of the present invention;

FIG. 3 is a schematic diagram showing an example of the composition of a scope information storage section of the scope descriptor object of FIG. 2;

FIG. 4 is a schematic diagram showing an example of an instance tree;

FIG. 5 is a schematic diagram showing an example of the change of the contents of a stack area of the scope descriptor object of FIG. 2 when the scope descriptor object moves in the instance tree;

FIG. 6 is a flow chart showing the operation of an agent of a management target device of the OSI network management system of FIG. 1 which generates the scope descriptor object;

FIG. 7 is a flow chart showing an example of the operation of the scope descriptor object of FIG. 2 which moves in the instance tree and extracts one or more instances that are designated by a starting position and a scope condition;

FIG. 8 is a flow chart showing an example of the movement of the scope descriptor object in a step S64 of FIG. 7 according to a depth first searching mode;

FIG. 9A is a flow chart showing an example of movement possibility judgment of a step S72 of FIG. 8 when the scope descriptor object tries to go down in the instance tree;

FIG. 9B is a flow chart showing an example of movement possibility judgment of a step S77 of FIG. 8 when the scope descriptor object tries to go up in the instance tree;

FIG. 10 is a schematic diagram showing a scope descriptor object which executes a scope processing method in accordance with a second embodiment of the present invention; and

FIG. 11 is a flow chart showing an example of the operation of the scope descriptor object of FIG. 10 which moves in the instance tree and extracts one or more instances that are designated by a starting position, a scope condition and a filtering condition.

### DESCRIPTION OF THE PREFERRED EMBODIMENTS

Referring now to the drawings, a description will be given in detail of preferred embodiments in accordance with the present invention.

[Embodiment 1]

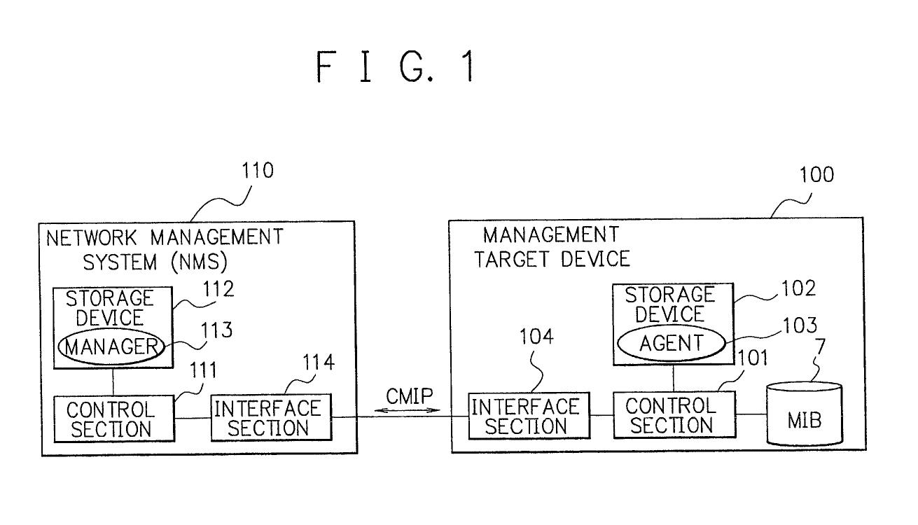

First, “scope processing” which is executed in the OSI network management system of FIG. 1 will be explained briefly. The scope processing is executed by an agent 103 of a management target device 100 of the OSI network management system of FIG. 1 for selecting and extracting one or more instances from the MIB (Management Information Base) 7. As mentioned before, the term “instance” (in the strict sense of the word) means a set of information concerning a device (card, shelf, rack, etc.) of the management target device 100 which has been stored in the MIB 7, however, the term will also be used in the following description in some wider meanings. Further, in the following description, the operation of the agent 103 (or a “scope descriptor object” which will be explained below) for extracting an instance from the MIB 7 will also be expressed as “extract an instance from the instance tree”. The instance tree stored in the MIB 7 has a root at which an instance exists, and one or more instances following the aforementioned instance exist at nodes of branches of the instance tree.

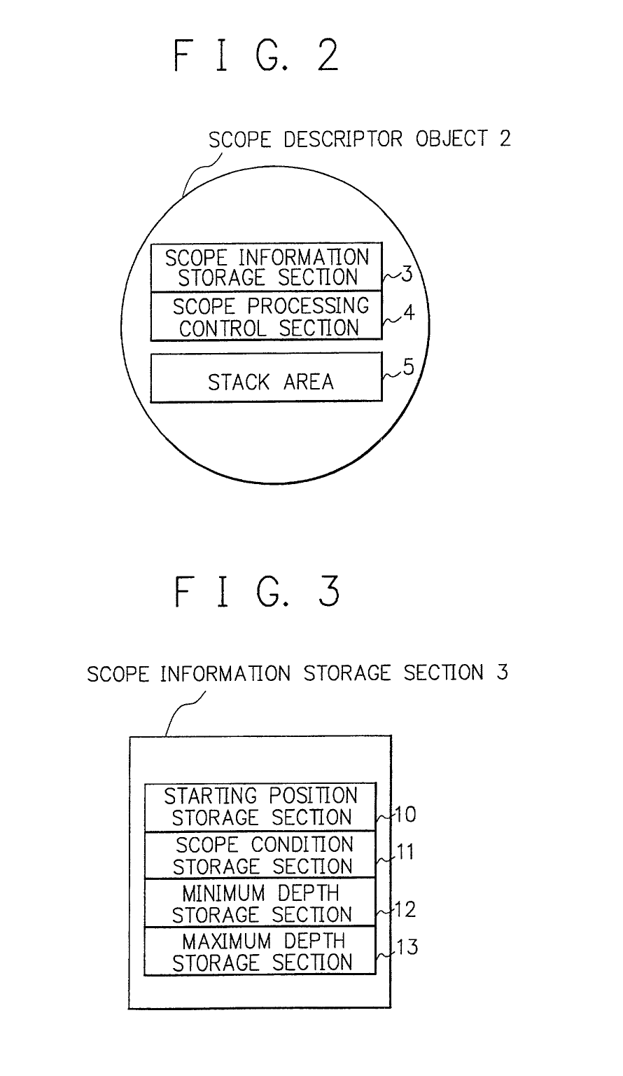

FIG. 2 is a schematic diagram showing a scope descriptor object 2 which executes a scope processing method in accordance with a first embodiment of the present invention. The scope descriptor object 2 is an object (software module) in the object-oriented technology, which extracts one or more instances from the instance tree.

The scope descriptor object 2 shown in FIG. 2 includes a scope information storage section 3, a scope processing control section 4 and a stack area 5. The scope information storage section 3 stores conditions (scope conditions) concerning the scope processing.

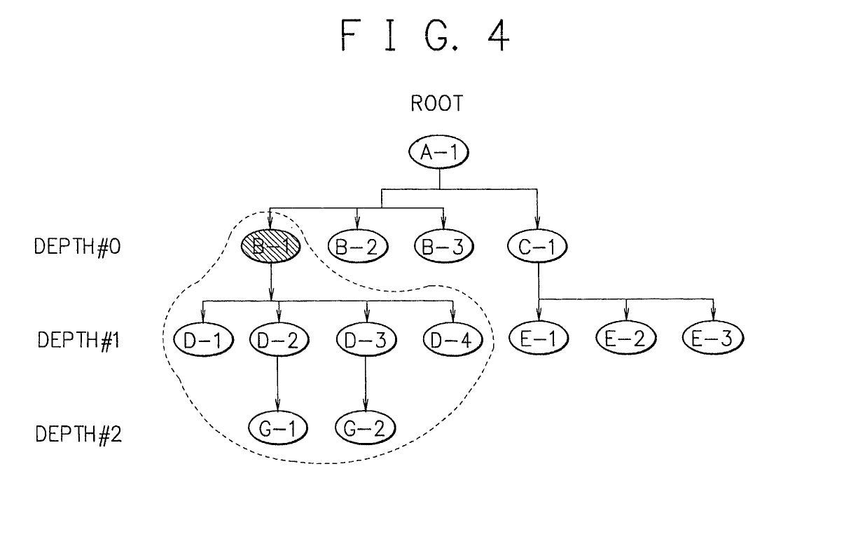

FIG. 3 is a schematic diagram showing an example of the composition of the scope information storage section 3 of the scope descriptor object 2 of FIG. 2. The scope information storage section 3 shown in FIG. 3 includes a starting position storage section 10, a scope condition storage section 11, a minimum depth storage section 12 and a maximum depth storage section 13. The starting position storage section 10 stores a “starting position” of the scope processing. The scope processing is started from the starting position, and a “scope condition” which will be explained below is applied to an instance of the starting position. For example, when the starting position storage section 10 stores “B-1” (shown in the instance tree of FIG. 4) as the starting position, the extraction of one or more instances from the instance tree (that is, the scope processing) is conducted by applying the scope condition to the instance B-1. The details of the scope conditions will be explained below.

The scope condition storage section 11 stores one of the following scope conditions. A scope condition “baseObject” designates an instance that exists at the starting position of the instance tree. A scope condition “firstLevelOnly” designates one or more instances that exist on a first level (that is, a level whose depth is a step deeper (lower) than the starting position). A scope condition “wholeSubtree” designates all the instances existing at positions following the starting position (including the starting position). A scope condition “individualLevels” designates one or more instances that exist on a level whose depth is designated steps deeper than the starting position. A scope condition “baseToNthLevel” indicates all the instances that exist between the starting position and a designated (relative) depth. For example, when the starting position is “B-1” and the scope condition is “firstLevelOnly”, the scope descriptor object 2 selects and extracts the instances D-1, D-2, D-3 and D-4 shown in FIG. 4.

The minimum depth storage section 12 and the maximum depth storage section 13 store a “minimum depth” and a “maximum depth”, respectively. The “minimum depth” means the depth of the shallowest level in the area (of the instance tree) that is designated by the scope condition, and the “maximum depth” means the depth of the deepest level in the area designated by the scope condition. The “minimum depth” and the “maximum depth” are expressed in terms of relative depth with respect to the “starting position”. For example, the aforementioned scope condition “firstLevelOnly” designates a level that is a step lower than the starting position whose relative depth is 0, therefore, both the minimum depth and the maximum depth become 1 in this case.

The scope processing control section 4 stores or holds functions which are used for extracting instances from an area of the instance tree that is designated by the minimum depth and the maximum depth. The functions successively change the instance that is referred to and thereby extract one or more instances that are designated by the scope condition. Incidentally, in the following explanation, the changing of the referred instance in the instance tree will be expressed intuitively as “the scope descriptor object 2 moves in the instance tree”. The scope descriptor object 2 moves in the instance tree by calling and referring to the functions and thereby extracts one or more instances. The scope processing control section 4 also stores a “movement mode” (go down, go sideways, etc.) concerning the movement of the scope descriptor object 2 in the instance tree. The “movement mode” is first determined and designated when the scope descriptor object 2 is generated, and thereafter changed successively during the scope processing. The scope processing control section 4 also stores information concerning the current depth of the scope descriptor object 2 which is moving in the instance tree.

The stack area 5 has storage areas corresponding to the depths (levels) of the instance tree. Each storage area corresponding to each depth is used for storing “current position information” concerning the current position of the scope descriptor object 2 in the instance tree and “instance information” concerning an instance of the current position of the instance tree. The “instance information” is, for example, the address of the instance (a set of information concerning a device (card, shelf, rack, etc.) of the management target device 100) in the MIB 7. When the scope descriptor object 2 goes sideways in the instance tree, the current position information and the instance information are successively overwritten and updated in the storage area corresponding to the current depth. When the scope descriptor object 2 goes down in the instance tree, current position information and instance information with regard to the new position (after movement) are written in a storage area corresponding to the new depth. When the scope descriptor object 2 goes up in the instance tree, the information which has been stored in a storage area corresponding to the current depth (before movement) is deleted.

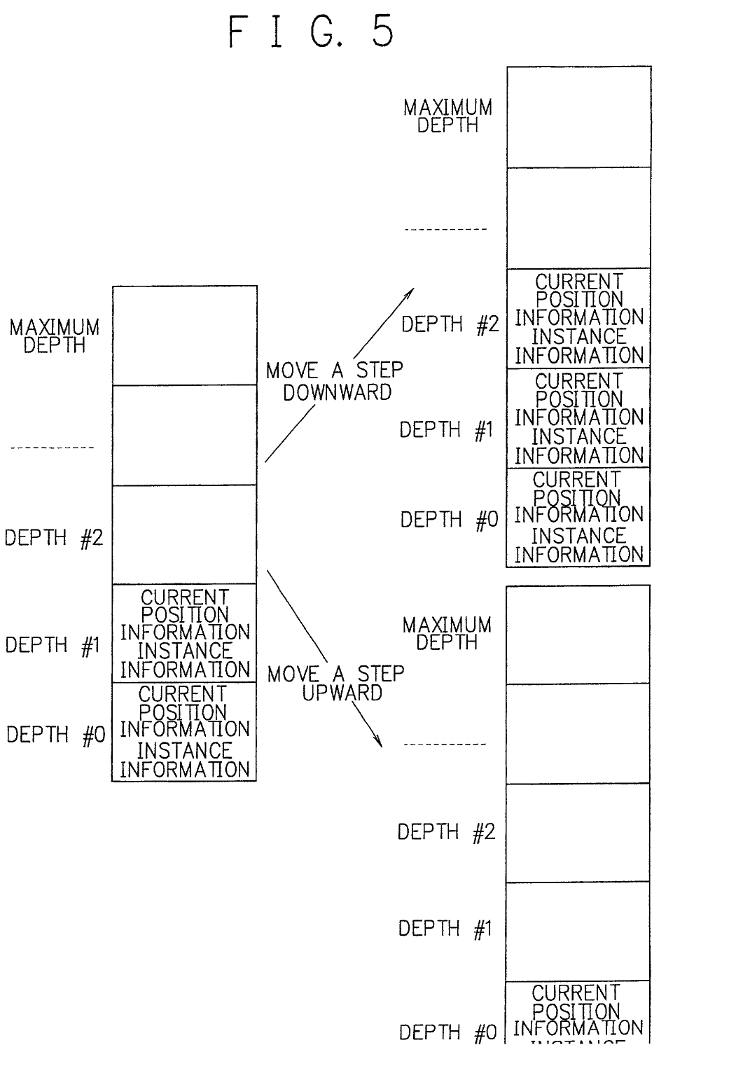

FIG. 5 is a schematic diagram showing an example of the change of the contents of the stack area 5 when the scope descriptor object 2 moves in the instance tree. FIG. 5 shows two cases: when the scope descriptor object 2 moves upward and downward from an instance at a depth #1. When the scope descriptor object 2 moves downward from the depth #1 to a depth #2, current position information and instance information with regard to the new position (after movement) are written in a storage area corresponding to the new depth #2. When the scope descriptor object 2 moves upward from the depth #1 to a depth #0, current position information and instance information which have been stored in a storage area corresponding to the current depth #1 (before movement) are deleted. When the scope descriptor object 2 moves sideways at the depth #1, the current position information and the instance information which have been stored in the storage area corresponding to the current depth #1 are updated (overwritten). Incidentally, the expression “move sideways” or “go sideways” in this explanation denotes “movement in the instance tree to the next instance on the same level”. The direction of the sideways movement is fixed to right or left. The following explanation will be given on the assumption that the scope descriptor object 2 moves to the right in the sideways movement.

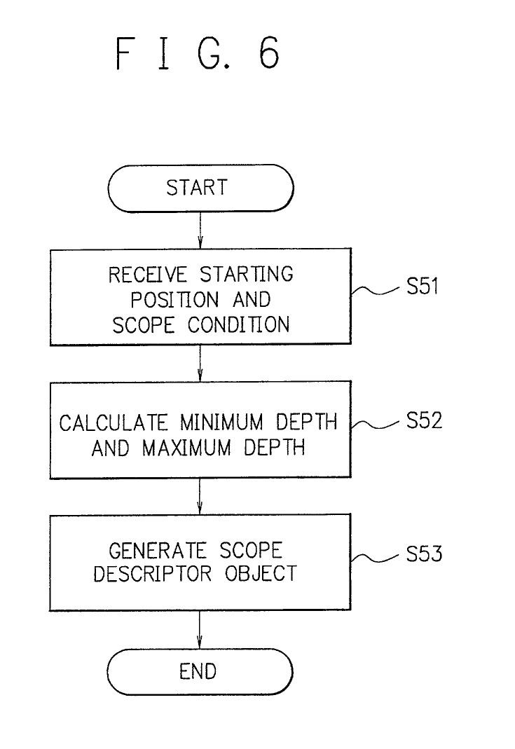

In the following, the operation of the OSI network management system of FIG. 1 by use of the scope processing method of the first embodiment of the present invention will be explained referring to FIGS. 6 through 9B.

FIG. 6 is a flow chart showing the operation of the agent 103 which generates the scope descriptor object 2 according to an instance extraction instruction which is supplied from the manager 113. First, the agent 103 receives the starting position and the scope condition from the manager 113 (step S51). Subsequently, the agent 103 calculates the minimum depth and the maximum depth based on the scope condition (step S52). In the following step S53, the agent 103 generates a scope descriptor object 2 (a scope descriptor instance corresponding to the instance extraction instruction from the manager 113) which holds the above conditions (starting position, scope condition, minimum depth, maximum depth) in the scope information storage section 3 and which has the scope processing control section 4 and the stack area 5. In the step S53, a movement mode “go down” is stored in the scope processing control section 4 as the initial value. By the above steps S51 through S53, the scope descriptor object 2 for executing the scope processing has been generated.

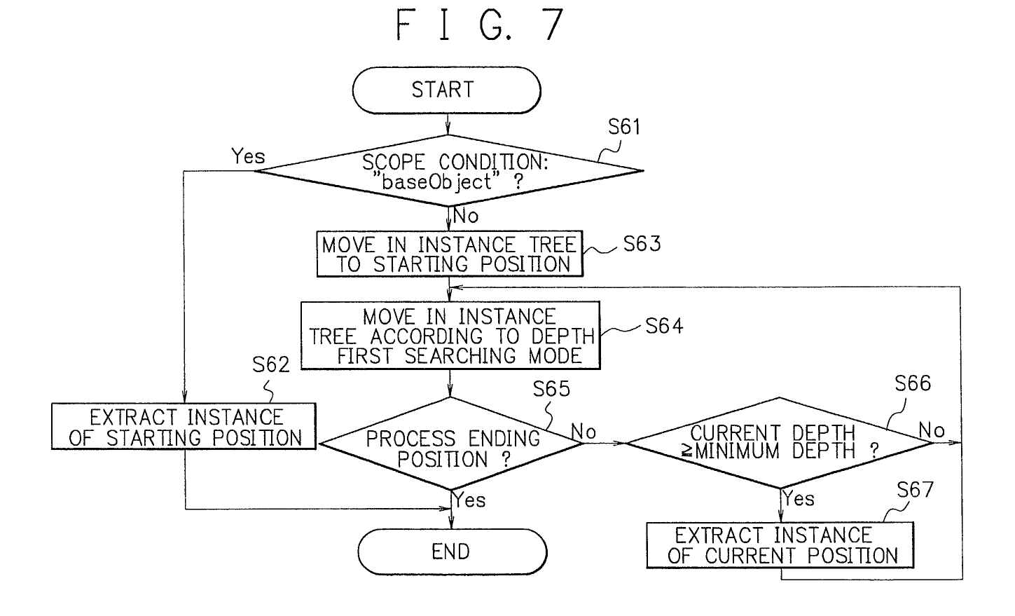

FIG. 7 is a flow chart showing an example of the operation of the scope descriptor object 2 which moves in the instance tree and extracts one or more instances that are designated by the starting position and the scope condition. In the flow chart of FIG. 7, the actual part (the subject) which executes each steps is the scope processing control section 4, however, the following explanation will be given regarding the scope descriptor object 2 as the subject for the sake of simplicity.

First, the scope descriptor object 2 judges whether or not the scope condition stored in the scope condition storage section 11 is “baseObject” (step S61). If the scope condition is “baseObject” (“Yes” in the step S61), the scope descriptor object 2 moves in the instance tree to the starting position and extracts an instance of the starting position (step S62), thereby the scope processing is completed. Incidentally, in the case where the scope condition is “baseObject”, it is also possible to extract the instance of the starting position without generating and using the scope descriptor object 2.

If the scope condition is not “baseObject” (“No” in the step S61), the scope descriptor object 2 in the instance tree moves into an instance that is designated as the starting position (step S63). The movement mode stored in the scope processing control section 4 has not altered yet, and thus the scope processing control section 4 in the step S63 holds “go down” as the movement mode.

Subsequently, the scope descriptor object 2 in the instance tree starts moving from the starting position according to “depth first searching mode” (step S64). On each movement of the scope descriptor object 2 in the instance tree, the information stored in the stack area 5 is updated in some ways depending on the direction of the movement. The scope descriptor object 2 moving in the instance tree according to the “depth first searching mode” stops the movement in some specific cases. The movement of the scope descriptor object 2 in the step S64 according to the depth first searching mode will be explained later.

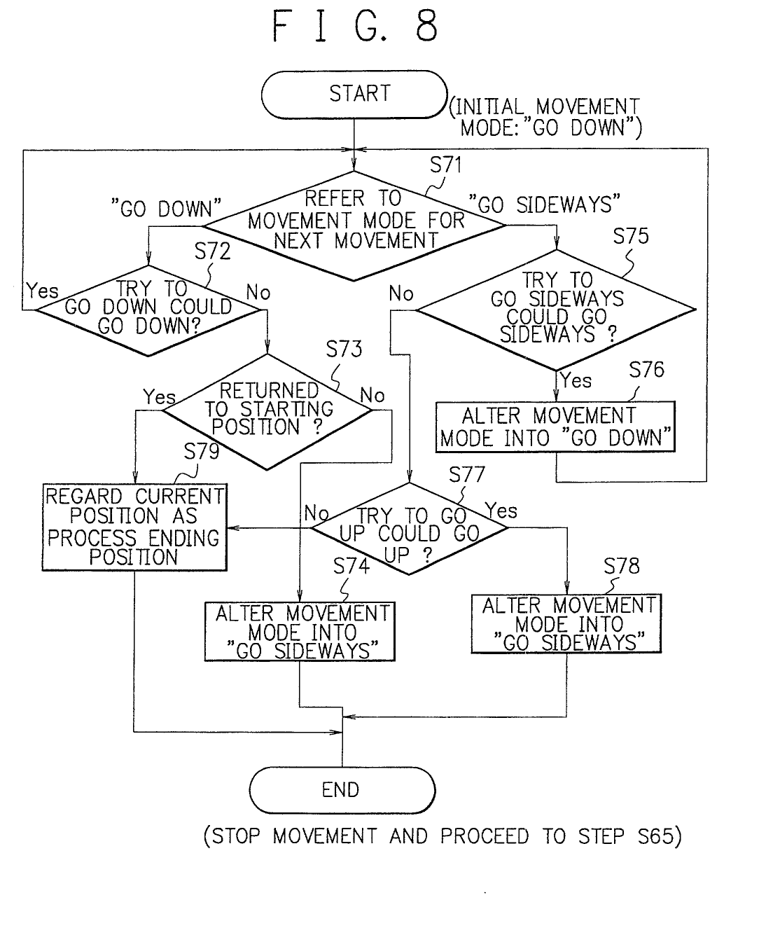

When the scope descriptor object 2 stopped moving in the step S64, the scope descriptor object 2 judges whether or not the current position is a predetermined process ending position (step S65). Information (search end flag) to be used for the judgment is set in a step S79 of FIG. 8 which will be explained later. If the current position where the scope descriptor object 2 stopped moving is the process ending position (“Yes” in the step S65), the scope processing is ended.

If the current position is not the process ending position (“No” in the step S65), the scope descriptor object 2 compares the current depth (i.e. the depth of the current position) with the minimum depth (step S66). Incidentally, the current depth and the minimum depth have been obtained as relative depths with respect to the starting position whose relative depth is 0. If the current depth is shallower than the minimum depth (“No” in the step S66), the scope descriptor object 2 restarts the movement of the step S64 from the current position. If the current depth is deeper than or equal to the minimum depth (“Yes” in the step S66), the scope descriptor object 2 extracts an instance of the current position (step S67) and restarts the movement of the step S64 from the current position.

Incidentally, the above expression “extract an instance” in the steps S67 and S62 in the embodiment means the extraction of the instance information (the address of the instance (a set of information concerning a device (card, shelf, rack, etc.) of the management target device 100) in the MIB 7) from the stack area 5. It is also possible to extract the actual instance (a set of information concerning a device (card, shelf, rack, etc.)) from the MIB 7 by use of the instance information (address etc.) in the steps S67 and S62 after the extraction of the instance information from the stack area 5. In the following description, the expression “extract an instance” can mean both cases (extraction of instance information, extraction of instance information and actual instance).

FIG. 8 is a flow chart showing an example of the movement of the scope descriptor object 2 in the step S64 according to the depth first searching mode. Similarly to the above explanation of FIG. 7, the actual part (the subject) which executes each steps of FIG. 8 is the scope processing control section 4, however, the following explanation will be given regarding the scope descriptor object 2 as the subject for the sake of simplicity.

First, the scope descriptor object 2 refers to the movement mode which has been stored in the scope processing control section 4 (step S71). If the movement mode is “go down”, the scope descriptor object 2 tries to go down (move to a level a step lower than the current level) in the instance tree (step S72). If the scope descriptor object 2 could go down in the step S72 (“Yes” in the step S72), the scope descriptor object 2 thereafter repeats the process from the step S71. If the scope descriptor object 2 could not go down in the step S72 (“No” in the step S72), the scope descriptor object 2 judges whether or not the scope descriptor object 2 has returned to the starting position (step S73). If the scope descriptor object 2 has not returned to the starting position yet (“No” in the step S73), the scope descriptor object 2 alters the movement mode stored in the scope processing control section 4 into “go sideways” (step S74), ends the depth first searching mode movement of the step S64, and proceeds to the step S65 of FIG. 7. If the scope descriptor object 2 has returned to the starting position (“Yes” in the step S73), the scope descriptor object 2 regards the current position as the aforementioned process ending position and sets the aforementioned search end flag (step S79), ends the depth first searching mode movement of the step S64, and proceeds to the step S65 of FIG. 7.

If the movement mode in the step S71 is “go sideways”, the scope descriptor object 2 tries to go sideways (move to a next instance in the same level) in the instance tree (step S75). Incidentally, the sideways movement of the step S75 is prohibited when the scope descriptor object 2 is at the starting position. If the scope descriptor object 2 could go sideways along a lateral branch of the instance tree (“Yes” in the step S75), the scope descriptor object 2 alters the movement mode for the next movement into “go down” (step S76) and thereafter repeats the process from the step S71. If the scope descriptor object 2 could not go sideways (“No” in the step S75), the scope descriptor object 2 tries to go up (move to a level a step higher than the current level) (step S77). If the scope descriptor object 2 could go up in the step S77, the scope descriptor object 2 alters the movement mode for the next movement into “go sideways” (step S78), ends the depth first searching mode movement of the step S64, and proceeds to the step S65 of FIG. 7. If the scope descriptor object 2 could not go up in the step S77 (that is, if the scope descriptor object 2 has returned to the starting position), the scope descriptor object 2 regards the current position as the process ending position and sets the search end flag (step S79), ends the depth first searching mode movement of the step S64, and proceeds to the step S65 of FIG. 7.

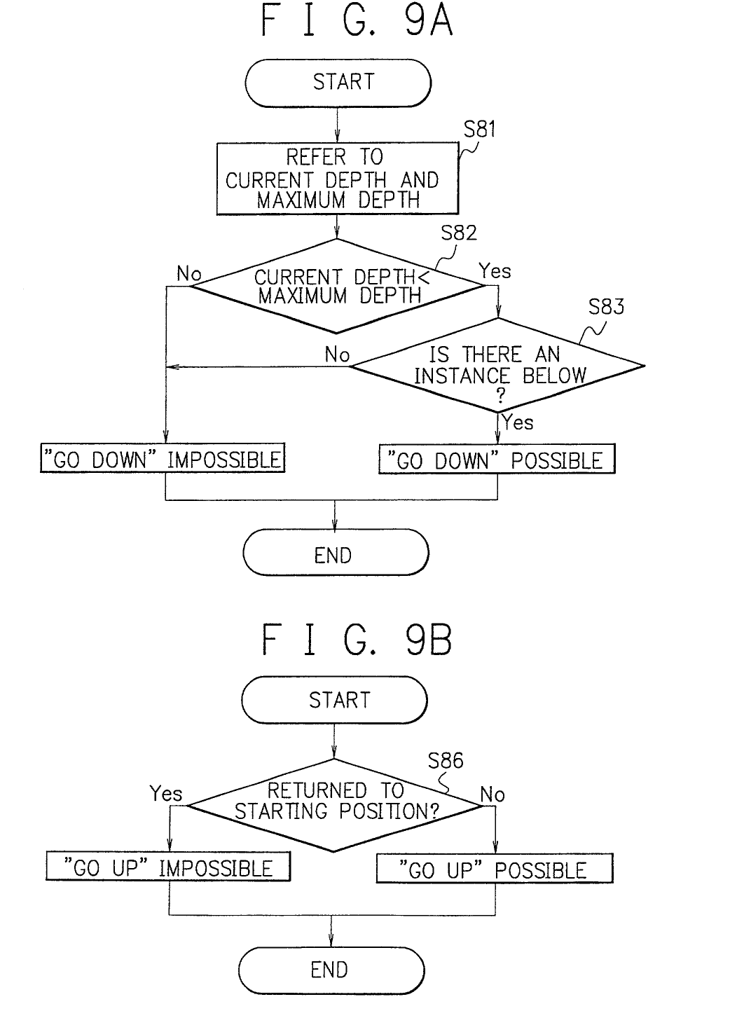

FIG. 9A is a flow chart showing an example of the movement possibility judgment of the step S72 when the scope descriptor object 2 tries to go down in the instance tree. On the judgment of the step S72, the scope descriptor object 2 first refers to the current depth (i.e. the depth of the current position) and the maximum depth (the depth of the deepest level in the area of the instance tree which is designated by the scope condition) (step S81). Incidentally, the current depth and the maximum depth have been obtained as relative depths from the starting position whose relative depth is 0. Subsequently, the scope descriptor object 2 compares the current depth with the maximum depth (step S82). If the current depth is smaller than the maximum depth (“Yes” in the step S82), the scope descriptor object 2 goes down in the instance tree if there is an instance below the current position (“Yes” in step S83). If there is no instance below the current position (“No” in the step S83) or if the current depth is not smaller than the maximum depth (“No” in the step S82), the movement “go down” is impossible (“No” in the step S72 of FIG. 8), and thus the scope descriptor object 2 proceeds to the step S73 of FIG. 8.

FIG. 9B is a flow chart showing an example of the movement possibility judgment of the step S77 when the scope descriptor object 2 tries to go up in the instance tree. On the judgment of the step S77, the scope descriptor object 2 judges whether or not it has returned to the starting position (step S86). If the scope descriptor object 2 has not returned to the starting position yet (“No” in the step S86), the scope descriptor object 2 goes up in the instance tree in the step S77. If the scope descriptor object 2 has returned to the starting position (“Yes” in the step S86), the movement “go up” is impossible (“No” in the step S77 of FIG. 8), and thus the scope descriptor object 2 proceeds to the step S79 of FIG. 8.

In the following, the operation of the scope descriptor object 2 under each scope condition will be explained in detail with reference to some concrete examples. The following explanation will be given on the assumption that the instance tree of FIG. 4 has been registered and stored in the MIB 7 of the management target device 100 shown in FIG. 1. The starting position is assumed to be B-1 of the instance tree of FIG. 4.

<Scope Condition: baseObject>

When the scope condition is “baseObject”, the scope descriptor object 2 generated by the process of the steps S51˜S53 of FIG. 6 executes the steps S61 and S62 of FIG. 7. Therefore, the scope descriptor object 2 extracts an instance of the starting position B-1 in the step S62 and ends the scope processing.

<Scope Condition: firstLevelOnly>

When the scope condition is “firstLevelOnly”, the area designated by the scope condition is a level that is a step lower than the starting position B-1, therefore, the agent 103 sets the minimum depth and the maximum depth to 1 and 1 and generates a scope descriptor object 2 having the depth information (steps S51˜S53 of FIG. 6).

After the step S61 of FIG. 7, the scope descriptor object 2 moves to the starting position B-1 (step S63). Subsequently, the scope descriptor object 2 moves in the instance tree according to the depth first searching mode (step S64). The movement mode “go down” has been stored in the scope condition storage section 11 as the initial movement mode and thus the scope descriptor object 2 first tries to go down in the instance tree (step S72). In this case, the scope descriptor object 2 can move to D-1 since the relative depth of the current position B-1 is 0 and the maximum depth is 1 (“Yes” in the step S82). The scope descriptor object 2 which moved to the position D-1 stores the current position (D-1) and information (address, for example) concerning an instance of the current position D-1 in an area of the stack area 5 corresponding to the depth #1. Subsequently, the process of the steps S71 and S72 are executed again. When the current position is D-1, the current depth and the maximum depth are both 1 (“No” in the step S82) and thus the scope descriptor object 2 can not go down further, therefore, the scope descriptor object 2 executes the steps S73 and S74 and stops the depth first searching mode movement of the step S64.

Subsequently, the scope descriptor object 2 executes the judgments of the steps S65 and S66. The relative depth of the current position is 1 and the minimum depth is 1 in the step S66, therefore, the scope descriptor object 2 proceeds to the step S67. The scope descriptor object 2 extracts an instance of the position D-1 from the area of the stack area 5 corresponding to the depth #1 (step S67), and restarts the movement from the position D-1 (step S64).

On the restart of the movement from the position D-1, the scope descriptor object 2 tries to go sideways since the movement mode has been altered into “go sideways” in the step S74 (step S71, step S75). At this time, the scope descriptor object 2 which moved from D-1 to D-2 updates the data (current position information, instance information) stored in the area of the stack area 5 corresponding to the depth #1 with the data concerning the position D-2. The scope descriptor object 2 which could move sideways in the step S75 alters the movement mode into “go down” (step S76), conducts the steps S71, S72, S73 and S74 (The relative depth of the position D-2 and the maximum depth are both 1 (“No” in the step S82) in the step S72 and thus the step S73 is conducted after the step S72.), and stops the depth first searching mode movement of the step S64.

Subsequently, the scope descriptor object 2 executes the judgments of the steps S65 and S66 and thereafter extracts an instance of the position D-2 in the step S67. Thereafter, the extraction of instances at the positions D-3 and D-4 are executed similarly. On the restart of the movement after the extraction of the instance at D-4, the scope descriptor object 2 can not go sideways in the step S75, and thus the scope descriptor object 2 tries to go up in the instance tree (step S77). In the case where the current position is D-4, the scope descriptor object 2 has not returned to the starting position, and thus the scope descriptor object 2 goes up to the upper position B-1, alters the movement mode into “go sideways” (step S78), and stops the depth first searching mode movement of the step S64.

Subsequently, the scope descriptor object 2 executes the judgments of the steps S65 and S66. At this time, the relative depth of the position B-1 is 0 and the minimum depth is 1 in the step S66, and thus the scope descriptor object 2 after the step S66 restarts the movement without executing the step S67. Therefore, the instance of the position B-1 is not extracted.

On the restart from the position B-1, the sideways movement from the starting position B-1 is impossible, and thus the scope descriptor object 2 conducts the steps S71, S75 and S77. In the step S77, the scope descriptor object 2 can not go up since it has already returned to the starting position (“Yes” in the step S86), therefore, the scope descriptor object 2 regards the current position as the process ending position (sets the search end flag) (step S79), and stops the depth first searching mode movement of the step S64. In the subsequent judgment of the step S65, the search end flag has been set and thus the scope descriptor object 2 ends the scope processing. Consequently, instances of the positions D-1, D-2, D-3 and D-4 (instances D-1, D-2, D-3 and D-4) could be extracted.

<Scope Condition: wholeSubtree>

When the scope condition is “wholeSubtree”, the area designated by the scope condition is all the instances existing at positions following the starting position B-1 (including the starting position B-1), therefore, the agent 103 sets the minimum depth and the maximum depth to 0 and 2 respectively and generates a scope descriptor object 2 having the depth information (steps S51˜S53 of FIG. 6).

Similarly to the case of “firstLevelOnly”, the scope descriptor object 2 moves to the starting position B-1 (step S63), moves to the position D-1, and updates the stack area 5. When the scope descriptor object 2 is at the position D-1, the relative depth of the current position D-1 is 1 and the maximum depth is 2 (“Yes” in the step S82), therefore, the scope descriptor object 2 can go down further if an instance exists under the position D-1. However, no instance exists under D-1 and the “go down” is impossible, therefore, the scope descriptor object 2 executes the steps S73 and S74 and stops the depth first searching mode movement of the step S64. Subsequently, similarly to the case of “firstLevelOnly”, the scope descriptor object 2 executes the judgments of the steps S65 and S66, extracts an instance of the position D-1 from the area of the stack area 5 corresponding to the depth #1 (step S67), and restarts the movement from the position D-1 (step S64).

On the restart of the movement from the position D-1, the scope descriptor object 2 moves to the position D-2 since the movement mode has been altered into “go sideways” in the step S74 (step S71, step S75), alters the movement mode into “go down” (step S76), and executes the steps S71 and S72. In the step S72, the relative depth of the position D-2 is 1 and the maximum depth is 2 (“Yes” in the step S82), and thus the scope descriptor object 2 goes down and moves to the position G-1. The scope descriptor object 2 which moved to the position G-1 stores the current position information (G-1) and information (address etc.) concerning an instance of the current position G-1 in an area of the stack area 5 corresponding to the depth #2. Subsequently, the scope descriptor object 2 repeats the steps S71 and S72. At this time, the relative depth of the position G-1 is 2 and the maximum depth is 2 (“No” in the step S82) and thus the scope descriptor object 2 can not go down further (“No” in the step S72), therefore, the scope descriptor object 2 executes the steps S73 and D74 and stops the depth first searching mode movement of the step S64. Subsequently, the scope descriptor object 2 executes the judgments of the steps S65 and S66, extracts an instance of the position G-1 from the area of the stack area 5 corresponding to the depth #2 (step S67), and restarts the movement from the position G-1 (step S64).

On the restart of the movement from the position G-1, the scope descriptor object 2 tries to go sideways in the instance tree since the movement mode has been altered into “go sideways” in the step S74 (step S71, step S75). However, no instance exists next to the instance G-1 on the same level and the “go sideways” is impossible, and thus the scope descriptor object 2 tries to go up in the instance tree (step S77). In the case where the current position is G-1, the scope descriptor object 2 which has not returned to the starting position B-I (“No” in the step S86) goes up to the position D-2. At this time, the scope descriptor object 2 deletes the information (current position information, instance information) which has been stored in a storage area of the stack area 5 corresponding to the depth #2. Subsequently, the scope descriptor object 2 alters the movement mode into “go sideways” (step S78) and stops the depth first searching mode movement of the step S64. Subsequently, the scope descriptor object 2 executes the judgments of the steps S65 and S66, extracts an instance of the position D-2 from the area of the stack area 5 corresponding to the depth #1 (step S67), and restarts the movement from the position D-2 (step S64).

Thereafter, the extraction of instances at the positions G-2, D-3 and D-4 are executed similarly. On the restart of the movement after the extraction of the instance at D-4, the scope descriptor object 2 can not go sideways in the step S75, and thus tries to go up in the instance tree (step S77). In the case where the current position is D-4, the scope descriptor object 2 has not returned to the starting position B-1 (“No” in the step S86), and thus the scope descriptor object 2 goes up to the upper position B-1. At this time, the scope descriptor object 2 deletes the information (current position information, instance information) which has been stored in a storage area of the stack area 5 corresponding to the depth #1. Subsequently, the scope descriptor object 2 alters the movement mode into “go sideways” (step S78), and stops the depth first searching mode movement of the step S64. Subsequently, the scope descriptor object 2 executes the judgments of the steps S65 and S66, extracts an instance of the position B-1 from the area of the stack area 5 corresponding to the depth #0 (step S67), and restarts the movement from the position B-1 (step S64).

On the restart of the movement from the position B-1, the scope descriptor object 2 executes the steps S71, S75 and S77. In the step S77, the scope descriptor object 2 which has already returned to the starting position B-1 (“Yes” in the step S86) can not go up in the instance tree, therefore, the scope descriptor object 2 regards the current position B-1 as the process ending position and sets the search end flag (step S79), and stops the depth first searching mode movement of the step S64. Subsequently, the scope descriptor object 2 ends the scope processing according to the judgment of the step S65. Consequently, instances of the positions D-1, G-1, D-2, G-2, D-3, D-4 and B-1 (instances D-1, G-1, D-2, G-2, D-3, D-4 and B-1) could be extracted.

<Scope Condition: individualLevels>

When the scope condition is “individualLevels” and “depth=2” is designated, the area designated by the scope condition is a level that is two steps lower than the starting position B-1, therefore, the agent 103 sets the minimum depth and the maximum depth to 2 and 2 and generates a scope descriptor object 2 having the depth information (steps S51˜S53 of FIG. 6).

The scope descriptor object 2 moves to the starting position B-1 (step S63), goes down to the position D-1 (step S71, step S72), executes the steps S73 and S74, and stops the depth first searching mode movement of the step S64 in the same ways as the case of “wholeSubtree”. Subsequently, the scope descriptor object 2 executes the judgments of the steps S65 and S66. In the step S66, the relative depth of the position D-1 is 1 and the minimum depth is 2 (“No” in the step S66), and thus the scope descriptor object 2 restarts the movement of the step S64 without extracting the instance of the position D-1 in the step S67.

After the restart from the position D-1, the scope descriptor object 2 reaches the position G-1 and stops the depth first searching mode movement of the step S64 in the same ways as the case of “wholeSubtree”. Subsequently, the scope descriptor object 2 executes the judgments of the steps S65 and S66. In the step S66, the relative depth of the position G-1 is 2 and the minimum depth is 2 (“Yes” in the step S66), and thus the scope descriptor object 2 extracts the instance of the position G-1 in the step S67 and thereafter restarts the movement of the step S64.

After the restart from the position G-1, the scope descriptor object 2 reaches the position D-2 and stops the movement in the same ways as the case of “wholeSubtree”. In the judgment of the step S66, the relative depth of the position D-2 is 1 and the minimum depth is 2 (“No” in the step S66), and thus the scope descriptor object 2 restarts the movement of the step S64 without extracting the instance of the position D-2 in the step S67.

Thereafter, the scope descriptor object 2 continues the process similarly and stops the depth first searching mode movement at the positions G-2, D-3 and D-4, in which the instance extraction of the step S67 is not executed at the positions D-3 and D-4 since the judgment of the step S66 is “No”. After the restart from the position D-4, the scope descriptor object 2 goes up to the position B-1 and stops the movement. At the position B-1, the scope descriptor object 2 does not execute the instance extraction of the step S67 since the relative depth of the position B-1 is 0 and the minimum depth is 2 (“No” in the step S66).

On the restart from the position B-1, the sideways movement from the starting position B-1 is impossible, and thus the scope descriptor object 2 conducts the steps S71, S75 and S77. In the step S77, the scope descriptor object 2 can not go up since it has already returned to the starting position (“Yes” in the step S86), therefore, the scope descriptor object 2 regards the current position B-1 as the process ending position (sets the search end flag) (step S79), and stops the depth first searching mode movement of the step S64. In the subsequent judgment of the step S65, the search end flag has been set and thus the scope descriptor object 2 ends the scope processing. Consequently, instances of the positions G-1 and G-2 (instances G-1 and G-2) could be extracted.

<Scope Condition: baseToNthLevel>

When the scope condition is “baseToNthLevel” and “depth=1” is designated, the area designated by the scope condition is the starting position B-1 and a level that is a step lower than the starting position B-1, therefore, the agent 103 sets the minimum depth and the maximum depth to 0 and 1 and generates a scope descriptor object 2 having the depth information (steps S51˜S53 of FIG. 6).

The scope descriptor object 2 moves to the starting position B-1 (step S63), goes down to the position D-1 (step S71, step S72), executes the steps S73 and S74, and stops the depth first searching mode movement of the step S64. Subsequently, the scope descriptor object 2 executes the judgments of the steps S65 and S66. In the step S66, the relative depth of the position D-1 is 1 and the minimum depth is 0 (“Yes” in the step S66), and thus the scope descriptor object 2 extracts the instance of the position D-1 in the step S67 and thereafter restarts the movement of the step S64. After the restart from the position D-1, the scope descriptor object 2 moves to the position D-2 in the same way as the cases of other movement modes. In this case, the relative depth of the current position D-2 is 1 and the maximum depth is 1 (“No” in the step S82) and thus the scope descriptor object 2 does not go down to the lower position G-1 (“No” in the step S72). Subsequently, the scope descriptor object 2 stops the depth first searching mode movement of the step S64 after executing the steps S73 and S74 and extracts the instance of the position D-2 (step S67). Thereafter, the extraction of instances at the positions D-3 and D-4 are executed similarly. After the instance extraction at the position D-4, the instance of the starting position B-1 is extracted in the same way as the case of “wholeSubtree”, and the scope processing is ended. Consequently, instances of the positions D-1, D-2, D-3, D-4 and B-1 (instances D-1, D-2, D-3, D-4 and B-1) could be extracted.

Incidentally, while the above explanations have been given taking a case where the starting position is the position B-1 as an example, the scope descriptor object 2 can also execute the extraction of desired instances successfully even if the starting position is a different position. Of course, the instance extraction by the scope descriptor object 2 is done correctly even if the depth (depth=1, 2, etc.) which is designated in the case of “individualLevels” or “baseToNthLevel” is changed.

As described above, in the scope processing method and the scope processing device in accordance with the first embodiment of the present invention, the scope descriptor object 2 moves in the area that is designated by the starting position and the scope condition and does not move to instances out of the designated area. The scope descriptor object 2 does not have to visit all the instances in the instance tree. Therefore, the time necessary for the scope processing can be reduced considerably.

Further, the scope descriptor object 2 which holds the current depth information can judge and recognize the current depth (the depth of the instance that is being referred to), therefore, each instance in the tree is not required to hold depth information of its own and inform the scope descriptor object 2 of the depth information. Therefore, necessary storage area in the MIB 7 can be reduced in comparison with the conventional scope processing method.

[Embodiment 2]

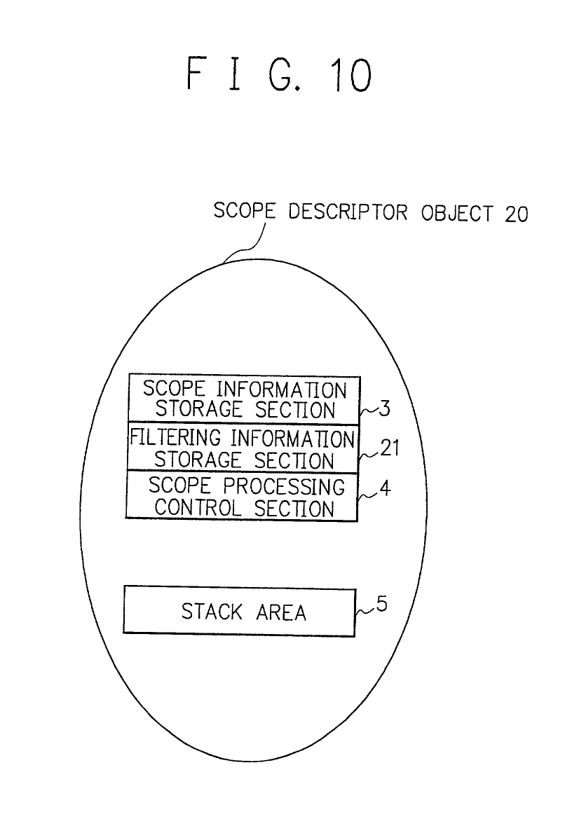

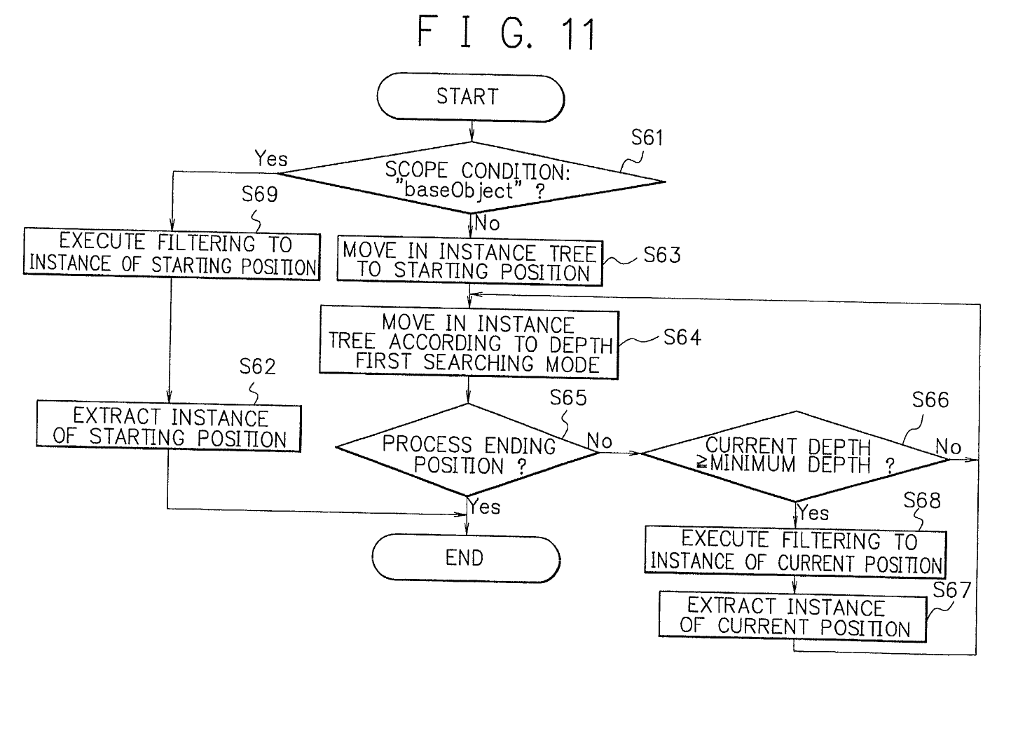

In the following, a second embodiment of the present invention will be explained in detail referring to FIGS. 10 and 11. In the scope processing method of the second embodiment, when the instance of the starting position and/or instances of positions designated by the scope condition are extracted, instances having predetermined specific “attributes” are selected and only such instances are extracted.

FIG. 10 is a schematic diagram showing a scope descriptor object 20 which executes the scope processing method of the second embodiment of the present invention. The scope descriptor object 20 shown in FIG. 10 includes a filtering information storage section 21 in addition to the scope information storage section 3, the scope processing control section 4 and the stack area 5 of the scope descriptor object 2 of the first embodiment. The filtering information storage section 21 stores filtering conditions to be used for extracting instances having specific attributes.

The scope descriptor object 20 is generated almost in the same way as the scope descriptor object 2 of the first embodiment which is generated by the process of FIG. 6, except that the agent 103 receives a filtering condition from the manager 113 together with the scope condition and the starting position in the step S51, and generates a scope descriptor object 20 that also holds the filtering condition in the filtering information storage section 21 in the step S53.

FIG. 11 is a flow chart showing an example of the operation of the scope descriptor object 20 which moves in the instance tree and extracts one or more instances that are designated by the starting position, the scope condition and the filtering condition. In FIG. 11, the processes of the steps S61˜S67 are the same as those of FIG. 7. The flow chart of FIG. 11 further includes filtering steps S68 and S69. In the step S68, filtering is executed to the instance of the current position (where the scope descriptor object 20 has stopped the depth first searching mode movement of the step S64). In the filtering of the step S68, it is judged whether or not the attribute of the instance of the current position satisfies the filtering condition which has been stored in the filtering information storage section 21. Therefore, only instances satisfying the filtering condition are extracted in the following step S67.

In the case where the scope condition is “baseObject” in the step S61, the scope descriptor object 20 judges whether or not the attribute of the instance of the starting position satisfies the filtering condition stored in the filtering information storage section 21 (step S69). Therefore, the instance of the starting position is not extracted in the following step S62 if the instance does not satisfy the filtering condition.

The “attribute” can be, for example, the serial number of the instance (device serial number etc.), a specific status of the instance (device status etc.), location name (“JAPAN” etc.), etc. The filtering condition can be set in various ways. For example, the filtering condition can be: “serial number≧5”, “a specific status of the instance=0”, “the location name includes a character string “JAPAN””, etc.

In the following, the operation of the OSI network management system of FIG. 1 by use of the scope processing method of the second embodiment of the present invention will be explained referring to FIG. 11. In the following explanation, it is assumed that the instance tree of FIG. 4 has been stored in the MIB 7 of the management target device 100 and only instances of the positions D-1 and D-2 of the instance tree have specific attribute “A”. The attribute “A” can be “serial number≧5”, for example. In the step S51 of FIG. 6, “B-1” is inputted as the starting position and the attribute “A” is inputted as the filtering condition.

<Scope Condition: firstLevelOnly>

The operation of the scope descriptor object 20 will hereafter be explained taking the case where the scope condition is “firstLevelOnly” as an example. The scope descriptor object 20 moves in the instance tree according to the depth first searching mode in the step S64 in the same ways as the scope descriptor object 2 of the first embodiment. On each stop of the movement, the scope descriptor object 20 executes the steps S65, S66, S68 and S67, and thereafter restarts the movement of the step S64. The movement according to the depth first searching mode is conducted in the same as the first embodiment, and thus the scope descriptor object 20 stops the movement at the positions D-1, D-2, D-3 and D-4. The filtering of the step S68 is executed on each stop of the movement, in which the instances of the positions D-1 and D-2 having the specific attribute “A” pass the filtering. Therefore, the scope descriptor object 20 extracts the instances of the positions D-1 and D-2 in the step S67.

On the other hand, when the scope descriptor object 20 stopped the movement at the positions D-3 or D-4, the instances at the positions D-3 and D-4 which do not have the attribute “A” do not pass the filtering. Therefore, the scope descriptor object 20 does no extract the instances of the positions D-1 and D-2 in the step S67.

<Scope Condition: wholeSubtree, individualLevels, baseToNthLevel>

Also in the cases where the scope condition is “wholeSubtree”, “individualLevels” or “baseToNthLevel”, the scope descriptor object 20 executes the filtering of the step S68 before the instance extraction of the step S67, therefore, only instances satisfying the filtering condition (that is, instances having the specific attribute “A”) are extracted in the step S67.

<Scope Condition: baseObject>

In the case where the scope condition is “baseObject” (“Yes” in the step S61), the filtering is executed to the instance of the starting position B-1 (step S69), and the instance is extracted if the instance passed the filtering (that is, if the instance has the specific attribute “A”) (step S62). However, the instance of the starting position B-1 in this explanation does not have the attribute “A” and does not pass the filtering, therefore, the instance B-1 is not extracted in the step S62.

As described above, in the scope processing method and the scope processing device in accordance with the second embodiment of the present invention, the filtering is executed on each extraction of an instance. Therefore, instances satisfying a specific filtering condition can be selected and extracted. The second embodiment is effective for cases where the OSI network management system is constructed based on the CMIP (Common Management Information Protocol) in which filtering of instances is sometimes necessary.

The filtering of the second embodiment is executed not after extracting all the instances satisfying the scope condition, but on each extraction of the instance. Only instances satisfying both the scope condition and the filtering condition are extracted successively, therefore, there is no need to prepare a large buffer area in the management target device 100 (storage device 102 or agent 103).

As set forth hereinabove, in the scope processing method and the scope processing device in accordance with the present invention, desired instances are extracted by the scope descriptor object (2, 20) which moves in an area of the instance tree that is designated by the starting position and the scope condition. Therefore, the scope descriptor object (2, 20) does not have to move throughout the instance tree and the scope processing can be completed in a short time.

The scope processing method of the present invention can, for example, be implemented by use of a machine-readable or computer-readable record medium (semiconductor memory, magnetic disk, etc.) which stores a program for instructing a computer etc. to execute the scope processing method. In such cases, the program stored in the record medium is read out and controls the operation of the computer etc., thereby the scope processing method of the present invention is implemented.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A scope processing method for extracting one or more instances from an instance tree which has been stored in a database, wherein:
the instances are extracted from the instance tree by use of a scope descriptor object which moves in an area of the instance tree that is designated by a starting position and a scope condition.

2. A scope processing method as claimed in claim 1, wherein the scope descriptor object which moves in the area designated by the starting position and the scope condition moves according to the following steps:
a movement starting step in which the scope descriptor object starts the movement in the instance tree from the starting position;
a downward movement step in which the scope descriptor object at an instance of the instance tree generally goes down in the instance tree to an instance a step lower than the current instance if possible;
a sideways movement step which is executed when the scope descriptor object could not go down in the downward movement step or when the scope descriptor object went up in the instance tree, in which the scope descriptor object goes sideways in the instance tree to an instance next to the current instance if possible;
an upward movement step which is executed when the scope descriptor object could not go sideways in the sideways movement step, in which the scope descriptor object goes up in the instance tree to an instance a step higher than the current instance if possible; and
a movement ending step in which the scope descriptor object ends the movement in the instance tree when the scope descriptor object returned to the starting position.

3. A scope processing method as claimed in claim 2, wherein when the scope descriptor object moves in the area designated by the starting position and the scope condition,
the scope descriptor object stops the movement in the instance tree when the scope descriptor object could not go down in the downward movement step, when the scope descriptor object could not go sideways in the sideways movement step and went up in the upward movement step, and when the scope descriptor object returned to the starting position, and
the scope descriptor object which stopped the movement in the instance tree judges whether or not the current position is within the area designated by the starting position and the scope condition, extracts the instance of the current position if the current position is within the designated area, and restarts the movement in the instance tree from the current position if the scope descriptor object has not returned to the starting position.

4. A scope processing method as claimed in claim 3, wherein when the scope descriptor object extracts the instance of the current position, the instance is extracted if the instance satisfies a filtering condition.

5. A scope processing method as claimed in claim 3, wherein:
the scope descriptor object includes a stack area having areas corresponding to each relative depth with respect to the starting position, and
when the scope descriptor object went down in the downward movement step, information concerning an instance of the position after movement is stored in an area of the stack area corresponding to the relative depth of the position after movement, and
when the scope descriptor object went sideways in the sideways movement step, information concerning an instance of the position after movement is stored in an area of the stack area corresponding to the relative depth of the current position, and
when the scope descriptor object went up in the upward movement step, information concerning an instance of the position before movement is deleted from an area of the stack area corresponding to the relative depth of the position before movement, and
when the scope descriptor object extracts an instance of the current position, the scope descriptor object extracts the information concerning the instance from the area of the stack area corresponding to the relative depth of the current position.

6. A scope processing method as claimed in claim 5, wherein the information concerning the instance is information indicating the address of the instance which has been stored in a database such as an MIB (Management Information Base).

7. A scope processing method as claimed in claim 1, wherein the instance is a set of information concerning a device of a management target device.

8. A scope processing method as claimed in claim 7, wherein the management target device is a management target device in an OSI (Open Systems Interconnection) network management system.

9. A scope processing device of a management target device for extracting one or more instances from an instance tree which has been stored in a database, wherein:
the scope processing device extracts the instances from the instance tree by use of a scope descriptor object which moves in an area of the instance tree that is designated by a starting position and a scope condition.

10. A scope processing device as claimed in claim 9, wherein the scope descriptor object which moves in the area designated by the starting position and the scope condition moves according to the following steps:
a movement starting step in which the scope descriptor object starts the movement in the instance tree from the starting position;
a downward movement step in which the scope descriptor object at an instance of the instance tree generally goes down in the instance tree to an instance a step lower than the current instance if possible;
a sideways movement step which is executed when the scope descriptor object could not go down in the downward movement step or when the scope descriptor object went up in the instance tree, in which the scope descriptor object goes sideways in the instance tree to an instance next to the current instance if possible;
an upward movement step which is executed when the scope descriptor object could not go sideways in the sideways movement step, in which the scope descriptor object goes up in the instance tree to an instance a step higher than the current instance if possible; and
a movement ending step in which the scope descriptor object ends the movement in the instance tree when the scope descriptor object returned to the starting position.

11. A scope processing device as claimed in claim 10, wherein when the scope descriptor object moves in the area designated by the starting position and the scope condition, the scope descriptor object stops the movement in the instance tree when the scope descriptor object could not go down in the downward movement step, when the scope descriptor object could not go sideways in the sideways movement step and went up in the upward movement step, and when the scope descriptor object returned to the starting position, and
the scope descriptor object which stopped the movement in the instance tree judges whether or not the current position is within the area designated by the starting position and the scope condition, extracts the instance of the current position if the current position is within the designated area, and restarts the movement in the instance tree from the current position if the scope descriptor object has not returned to the starting position.

12. A scope processing device as claimed in claim 11, wherein when the scope descriptor object extracts the instance of the current position, the instance is extracted if the instance satisfies a filtering condition.

13. A scope processing device as claimed in claim 11, wherein:
the scope descriptor object includes a stack area having areas corresponding to each relative depth with respect to the starting position, and
when the scope descriptor object went down in the downward movement step, information concerning an instance of the position after movement is stored in an area of the stack area corresponding to the relative depth of the position after movement, and
when the scope descriptor object went sideways in the sideways movement step, information concerning an instance of the position after movement is stored in an area of the stack area corresponding to the relative depth of the current position, and
when the scope descriptor object went up in the upward movement step, information concerning an instance of the position before movement is deleted from an area of the stack area corresponding to the relative depth of the position before movement, and
when the scope descriptor object extracts an instance of the current position, the scope descriptor object extracts the information concerning the instance from the area of the stack area corresponding to the relative depth of the current position.

14. A scope processing device as claimed in claim 13, wherein the information concerning the instance is information indicating the address of the instance which has been stored in a database such as an MIB (Management Information Base).

15. A scope processing device as claimed in claim 9, wherein the instance is a set of information concerning a device of the management target device.

16. A scope processing device as claimed in claim 15, wherein the management target device is a management target device in an OSI (Open Systems Interconnection) network management system.

17. A machine-readable record medium storing a program for instructing a computer etc. to execute a scope processing for extracting one or more instances from an instance tree which has been stored in a database, wherein:
the instances are extracted from the instance tree by use of a scope descriptor object which moves in an area of the instance tree that is designated by a starting position and a scope condition.

18. A machine-readable record medium as claimed in claim 17, wherein the scope descriptor object which moves in the area designated by the starting position and the scope condition moves according to the following steps:
a movement starting step in which the scope descriptor object starts the movement in the instance tree from the starting position;
a downward movement step in which the scope descriptor object at an instance of the instance tree generally goes down in the instance tree to an instance a step lower than the current instance if possible;
a sideways movement step which is executed when the scope descriptor object could not go down in the downward movement step or when the scope descriptor object went up in the instance tree, in which the scope descriptor object goes sideways in the instance tree to an instance next to the current instance if possible;
an upward movement step which is executed when the scope descriptor object could not go sideways in the sideways movement step, in which the scope descriptor object goes up in the instance tree to an instance a step higher than the current instance if possible; and
a movement ending step in which the scope descriptor object ends the movement in the instance tree when the scope descriptor object returned to the starting position.

19. A machine-readable record medium as claimed in claim 18, wherein when the scope descriptor object moves in the area designated by the starting position and the scope condition,
the scope descriptor object stops the movement in the instance tree when the scope descriptor object could not go down in the downward movement step, when the scope descriptor object could not go sideways in the sideways movement step and went up in the upward movement step, and when the scope descriptor object returned to the starting position, and
the scope descriptor object which stopped the movement in the instance tree judges whether or not the current position is within the area designated by the starting position and the scope condition, extracts the instance of the current position if the current position is within the designated area, and restarts the movement in the instance tree from the current position if the scope descriptor object has not returned to the starting position.

20. A machine-readable record medium as claimed in claim 19, wherein when the scope descriptor object extracts the instance of the current position, the instance is extracted if the instance satisfies a filtering condition.

21. A machine-readable record medium as claimed in claim 19, wherein:
the scope descriptor object includes a stack area having areas corresponding to each relative depth with respect to the starting position, and
when the scope descriptor object went down in the downward movement step, information concerning an instance of the position after movement is stored in an area of the stack area corresponding to the relative depth of the position after movement, and
when the scope descriptor object went sideways in the sideways movement step, information concerning an instance of the position after movement is stored in an area of the stack area corresponding to the relative depth of the current position, and
when the scope descriptor object went up in the upward movement step, information concerning an instance of the position before movement is deleted from an area of the stack area corresponding to the relative depth of the position before movement, and
when the scope descriptor object extracts an instance of the current position, the scope descriptor object extracts the information concerning the instance from the area of the stack area corresponding to the relative depth of the current position.

22. A machine-readable record medium as claimed in claim 21, wherein the information concerning the instance is information indicating the address of the instance which has been stored in a database such as an MIB (Management Information Base).

23. A machine-readable record medium as claimed in claim 17, wherein the instance is a set of information concerning a device of a management target device.

24. A machine-readable record medium as claimed in claim 23, wherein the management target device is a management target device in an OSI (Open Systems Interconnection) network management system.
